(19) United States
(12) Patent Application Publication
(10) Pub. No.: US 2014/0369554 A1
(43) Pub. Date: Dec. 18, 2014

(54) FACE BEAUTIFICATION SYSTEM AND METHOD OF USE THEREOF

(71) Applicant: Nvidia Corporation, Santa Clara, CA (US)

(72) Inventors: Elif Albuz, Santa Clara, CA (US); Colin Tracey, Santa Clara, CA (US); Navjot Garg, Santa Clara, CA (US); Yun-Ta Tsai, Santa Clara, CA (US); Dawid Pajak, Santa Clara, CA (US)

(73) Assignee: Nvidia Corporation, Santa Clara, CA (US)

(21) Appl. No.: 14/031,551

(22) Filed: Sep. 19, 2013

Related U.S. Application Data
(60) Provisional application No. 61/836,487, filed on Jun. 18, 2013.

(51) Int. Cl. G06T 5/20; G06K 9/00

(52) U.S. Cl. CPC G06T 5/20; G06K 9/00281
USPC 382/103

(57) ABSTRACT

A face beautification system and a method of face beautification. On embodiment of the face beautification system includes: (1) a coarse feature detector configured to generate an approximation of facial features in an image, (2) an edge-preserving filter configured to reduce distortions in the approximation, and (3) a feature enhancer operable to selectively filter a facial feature from said approximation and carry out an enhancement.

### CROSS-REFERENCE TO RELATED APPLICATION

This application claims the benefit of U.S. Provisional Application Ser. No. 61/863,487, filed by Albuz, et al., on Aug. 8, 2013, entitled “Method for Automatic Face Beautification in Real-Time Video Applications,” commonly assigned with this application and incorporated herein by reference.

### TECHNICAL FIELD

This application is directed, in general, to electronic image retouching and, more specifically, to real-time face beautification.

### BACKGROUND

Digital photography has made it possible for even the most modest photographer to retouch images. Retouching digital portraits, sometimes referred to as face beautification, has become particularly popular among digital camera users. With the advent of smart phones and ever more powerful mobile computing devices, particularly those with embedded digital cameras, face beautification reaches far beyond traditional desktop and laptop personal computers (PCs).

Face beautification has generally been limited to basic imperfections, color, and texture. The proliferation of digital cameras in mobile devices has fostered a fresh demand in more robust techniques that seek to improve the overall appeal of a human face. While improving the apparent appeal of a face may seem unconventional, and sometimes superficial, it has many practical uses, including: special effects, advertising, social media, and dating services, in addition to traditional applications such as professional photography and art.

Objective standards for face beautification remain elusive; however, statistical models have proven helpful in removing at least some of the subjectivity. Many variables contribute to the complexity of the problem of objectively characterizing face beautification, including: gender, ethnicity, culture, and age, among others. For these reasons, automated solutions are generally limited to specialized software designed to detect and remedy objectively identifiable imperfections in still images. To the extent a particular enhancement remains subjective, automated face beautification typically requires an affirmative action by the user. Additionally, manual steps are often available to remedy structural imperfections in the skin, mouth, nose, eyes, or other facial feature.

### SUMMARY

One aspect provides a face beautification system. In one embodiment, the system includes: (1) a coarse feature detector configured to generate an approximation of facial features in an image, (2) an edge-preserving filter configured to reduce distortions in the approximation, and (3) a feature enhancer operable to selectively filter a facial feature from said approximation and carry out an enhancement.

Another aspect provides a method of face beautification for an image. In one embodiment, the method includes: (1) applying a coarse feature mask to the image, (2) low-pass filtering the coarse feature mask, (3) detecting precise facial features in the coarse feature mask, and (4) employing a feature enhancement on the precise facial features.

Yet another aspect provides a computing device. In one embodiment, the device includes: (1) a camera operable to capture an image, and (2) a graphics processing unit (GPU) having: (2a) coarse feature masks operable to generate an approximation of facial features in the image, (2b) an edge-preserving filter configured to reduce distortions in the approximation, (2c) a precise feature mask operable to extract a facial feature from the approximation, and (2d) an enhancement processor configured to apply an enhancement to the facial feature.

### BRIEF DESCRIPTION

Reference is now made to the following descriptions taken in conjunction with the accompanying drawings, in which:

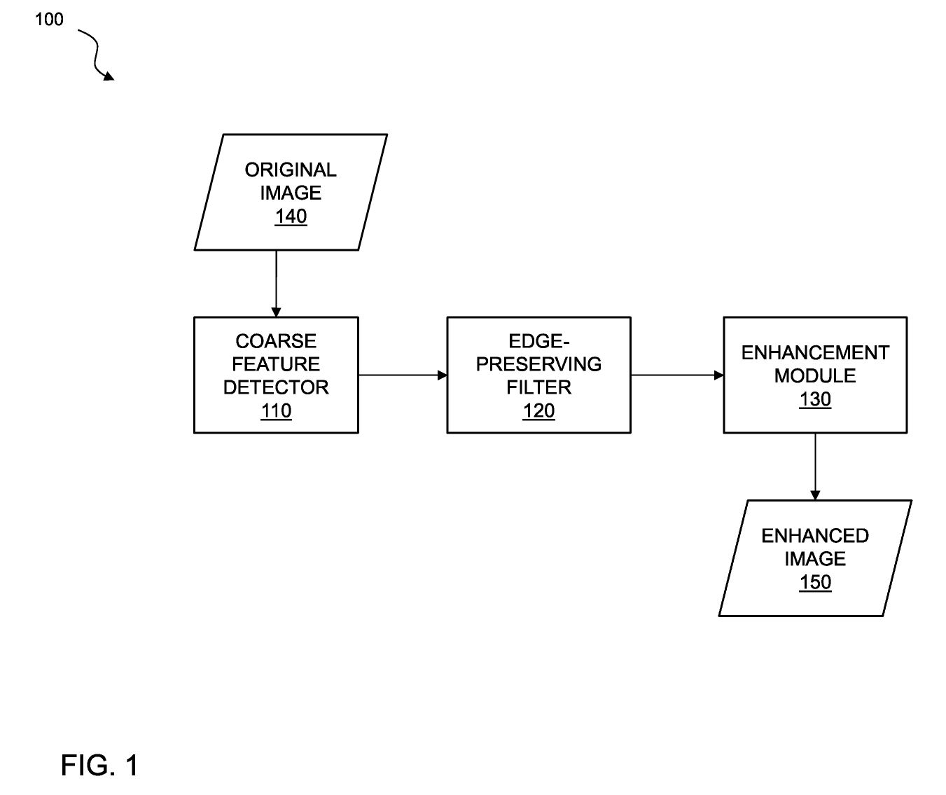

FIG. 1 is a block diagram of one embodiment of a face beautification system;

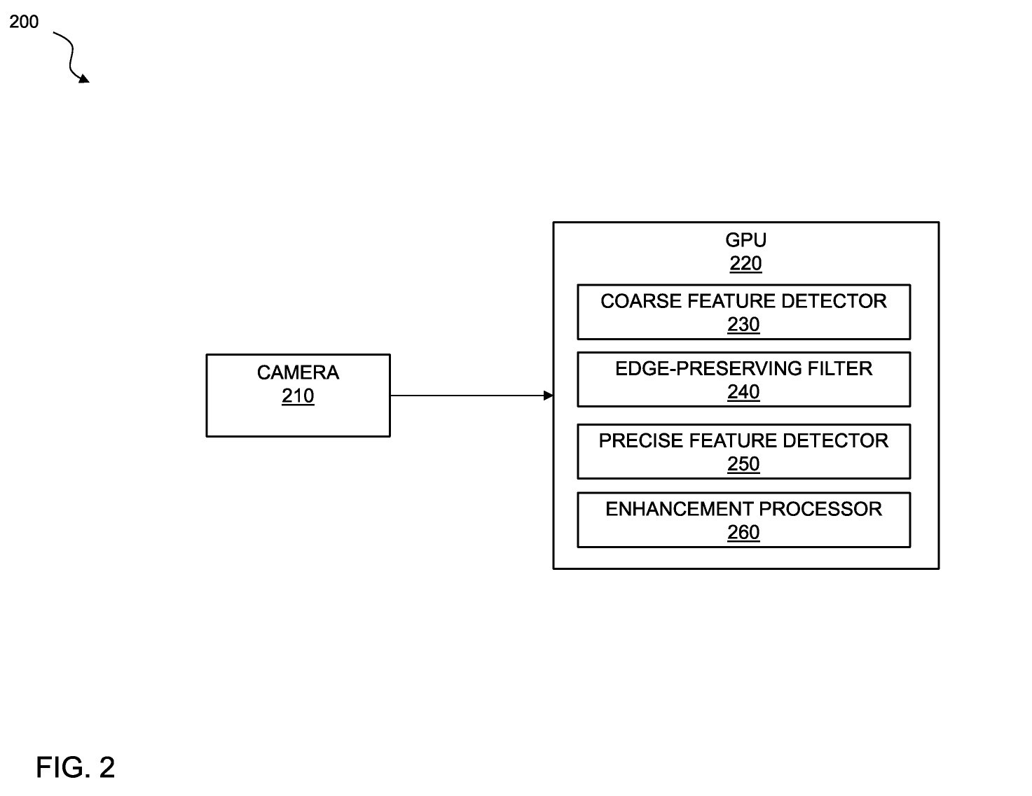

FIG. 2 is a block diagram of one embodiment of a computing system; and

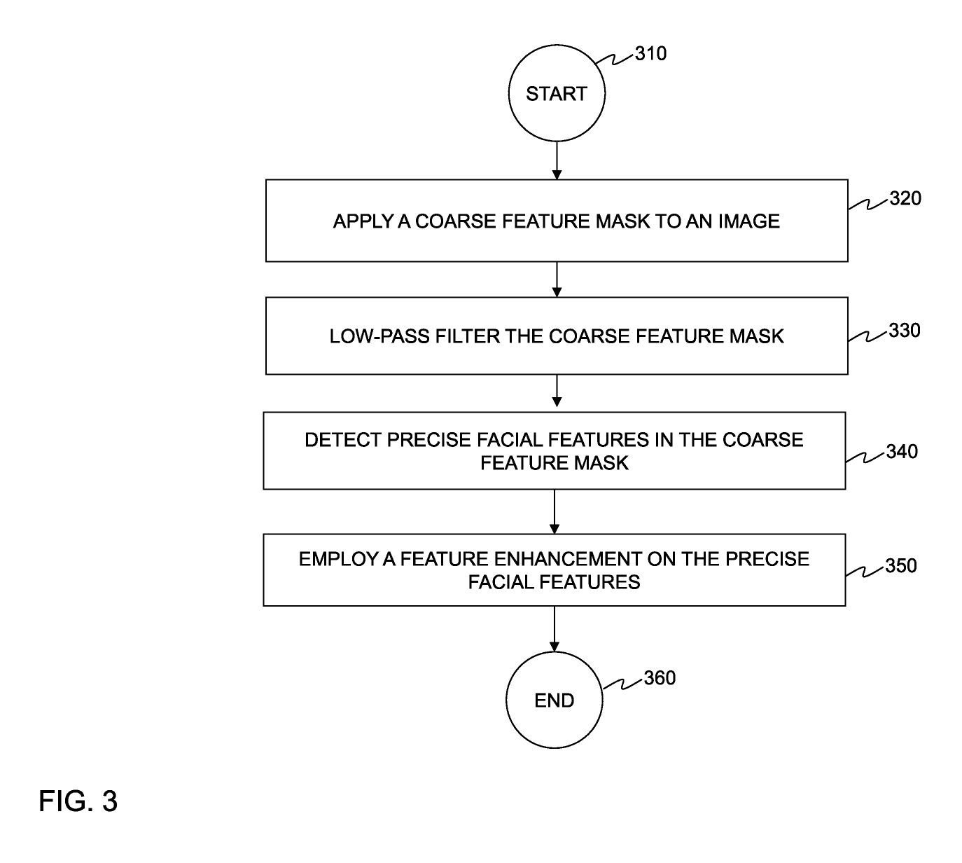

FIG. 3 is a flow diagram of one embodiment of a method of face beautification.

### DETAILED DESCRIPTION

It is realized herein that real-time face beautification is possible given the appropriate implementation. Real-time face beautification enables many video applications, including video conferencing and computational camera. It is further realized herein that real-time implementations of face beautification techniques, also called “feature enhancements,” allow for a more comprehensive, or “holistic,” face beautification on facial features, including but not limited to: skin, eyes, hair, nose, mouth, ears, chin, and cheeks.

It is realized herein that real-time face beautification can be embodied on a system-on-a-chip (SOC) with optimized features, such as filtering and sampling. For example, one embodiment of real-time face beautification is a graphics processing unit (GPU) configured for the various feature enhancements. It is realized herein that a coarse approximation of facial features and an edge-preserving filter may be used to localize facial features to a certain region of interest (ROI) within the image. A coarse approximation of facial features identifies the boundaries of the face and roughly detects major features, such as eyes, nose, and mouth. The edge-preserving filter refines the coarse approximation. It is realized herein the ROI should then be processed for precise feature detection. Precise feature detection labels each pixel in the ROA as belonging to the particular feature detected or not, identifying specific features to enhance, such as eye color, teeth, hairlines, and others. Precise feature detection offers increased accuracy and confidence in the location of the detected feature. A variety of conventional or later-developed face beautification techniques, or feature enhancements can then use the resulting precise feature mask. Additionally, post-processing can follow the enhancements to achieve additional effects, such as face glare and specular highlights of hair, among others.

FIG. 1 is a block diagram of one embodiment of a face beautification system 100. Face beautification system 100 includes a coarse feature detector 110, an edge-preserving filter 120, and an enhancement module 130. Face beautification system 100 can be implemented on a single processor, SOC, GPU, and others. Certain embodiments of face beautification system 100 are packaged along with a digital camera capable of capturing video frames or still images. Devices that could contain an embodiment of face beautification system 100 include mobile devices, such as digital cameras, smart phones, camera enabled cell phones, tablet computers, and laptop computers, among others. Other devices that could contain an embodiment of face beautification system 100 include desktop devices, such as desktop PCs and video conferencing equipment, among others.

An original image 140 is captured and passed to face beautification system 100 as an input. Original image 140 includes at least one human face. Original image 140 is first processed by coarse feature detector 110. Coarse feature detector 110 generates a coarse approximation of the facial features in original image 140 by localizing features to a certain region of interest within the image. Certain embodiments of coarse feature detector 110 include coarse feature masks formed by sampling original image 140 and deciding whether each sampled pixel is part of a facial feature or not. Use of a coarse approximation over something more precise yields significant time savings via lower sampling rates and lower decision thresholds. Although less computationally intense, coarse feature detector 110 can introduce distortions to the finished product, which can be mitigated by further processing.

Edge-preserving filter 120 receives the coarse feature representations detected by coarse feature detector 110. Edge-preserving filter 120, in certain embodiments, is simply a low-pass filter. In alternate embodiments, edge-preserving filter 120 is a domain transform filter. Edge-preserving filter 120 reduces the distortions introduced by coarse feature detector 110. Implementation of edge-preserving filter 120 on a GPU or SOC allows for its inclusion in face beautification system 100 without introducing unreasonable amounts of latency.

Enhancement module 130 operates on the filtered approximations of facial features yielded by a combination of coarse feature detector 110 and edge-preserving filter 120. Enhancement module, in certain embodiments, includes a precise feature detector and an enhancement processor. For example, one embodiment of an enhancement module could include a precise feature detector for detecting teeth and an enhancement processor for applying a whitening effect to the teeth. Certain embodiments of precise feature detection employ a precise feature mask that represents a particular facial feature. Construction of the feature mask would label each pixel within the ROI as belonging to the particular feature or not.

A wide variety of feature enhancements, such as teeth whitening, are possible, including: skin smoothing, re-colorization of skin, removal of color and structural imperfections on skin, increasing contrast and brightness of eyes (sclera brightening), increasing color saturation of iris, and modification of facial geometry, among many others. An enhanced image 150 results from processing at least one feature enhancement.

Multiple feature enhancements can be processed based on the filtered approximations. These multiple feature enhancements provide for a holistic face beautification system.

FIG. 2 is a block diagram of one embodiment of a computing system 200. Computing system 200 includes a camera 210 and a GPU 220, and is configured to carry out a face beautification process. Camera 210 is a digital camera capable of capturing still images or video frames. An original image captured by camera 210 is passed to GPU 220 for processing.

GPU 220 includes a coarse feature detector 230, an edge-preserving filter 240, a precise feature detector 250, and an enhancement processor 260. In certain embodiments, the components of GPU 220 are implemented as configurable hardware modules within the architecture of GPU 220 and having a software interface. In other embodiments, the components of GPU 220 are implemented as software modules. Selecting a hardware implementation versus a software implementation is a subjection matter, largely depending on the application and tolerance for latency. Certain hardware implementations offer faster processing at the expense of dynamic configuration. Certain software implementations are significantly more flexible, but cannot carry out face beautification processing as fast as the hardware alternatives.

Coarse feature detector 230 is configured to generate a coarse approximation of facial features present in the original image captured by camera 210. The coarse approximation is computationally efficient, requiring fewer samples and computations, and less time than more precise alternatives.

The coarse approximation can also introduce distortions to the enhanced image. Edge-preserving filter 240 mitigates the distortions by smoothing the coarse approximations while preserving the boundaries of facial features. Precise feature detector 250 detects particular facial features, such as eyes, ears, mouth, nose, hair, and others. Once the particular facial feature is detected, enhancement processor 260 carries out the actual enhancement, which typically includes some amount of filtering, gain, attenuation, or some other manipulation of the original image.

FIG. 3 is a flow diagram of one embodiment of a method of face beautification. The method begins in a start step 300. In a coarse detection step 320, a coarse feature mask is applied to an image. The results of the coarse feature mask can exhibit errors, or other forms of distortion. At least some of these distortions can be corrected in a filtering step 330. At filtering step 330 the coarse feature mask is operated on by an edge preserving filter, thereby preserving the boundaries of the facial features in the image.

In a precise detection step 340, precise facial features are detected for later processing of feature enhancements. In an enhancement step 350, a feature enhancement is employed on the precise facial features.

In alternate embodiments, the method further includes a post-processing step. Post-processing occurs after employing feature enhancements and can includes post-processing effects such as bloom, or face glare, and increased specular highlights of hair, among others. These additional effects operate to improve the overall appeal of faces in the image. The method then ends in an end step 360.

Those skilled in the art to which this application relates will appreciate that other and further additions, deletions, substitutions and modifications may be made to the described embodiments.

What is claimed is:

1. A face beautification system, comprising:
a coarse feature detector configured to generate an approximation of facial features in an image;
an edge-preserving filter configured to reduce distortions in said approximation; and
a feature enhancer operable to selectively filter a facial feature from said approximation and carry out an enhancement.

2. The face beautification system as recited in claim 1 wherein said coarse feature detector is a coarse feature mask.

3. The face beautification system as recited in claim 1 wherein said feature enhancer includes a precise feature mask and an enhancement processor.

4. The face beautification system as recited in claim 3 wherein said enhancement includes increasing contrast and brightness of eyes.

5. The face beautification system as recited in claim 1 further comprising a post-processing feature enhancer.

6. The face beautification system as recited in claim 1 wherein said face beautification system operates in real-time.

7. The face beautification system as recited in claim 6 wherein said image is a frame of video.

8. A method of face beautification for an image, comprising:
applying a coarse feature mask to said image;
filtering said coarse feature mask to preserve boundaries of facial features;
detecting precise facial features in said coarse feature mask; and
employing a feature enhancement on said precise facial features.

9. The method as recited in claim 8 wherein said filtering includes employing an edge-preserving filter.

10. The method as recited in claim 8 wherein said employing includes smoothing of skin.

11. The method as recited in claim 8 wherein said detecting includes active shape modeling (ASM).

12. The method as recited in claim 8 further comprising processing said image to add a post-processing effect.

13. The method as recited in claim 12 wherein said post-processing effect includes increasing specular highlights of hair.

14. The method as recited in claim 8 further comprising capturing said image.

15. A computing device, comprising:
a camera operable to capture an image; and
a graphics processing unit (GPU) having:
coarse feature masks operable to generate an approximation of facial features in said image,
an edge-preserving filter configured to reduce distortions in said approximation,
a precise feature mask operable to extract a facial feature from said approximation, and
an enhancement processor configured to apply an enhancement to said facial feature.

16. The computing device as recited in claim 15 wherein said camera is further operable to capture a plurality of video frames.

17. The computing device as recited in claim 15 wherein said edge-preserving filter includes a domain transform filter.

18. The computing device as recited in claim 15 wherein said GPU is operable to apply a plurality of enhancements in real-time.

19. The computing device as recited in claim 18 wherein said plurality of enhancements include skin beautification.

20. The computing device as recited in claim 19 wherein said skin beautification includes removal of color and structural imperfections of skin.
